(19) United States
(12) Patent Application Publication
(10) Pub. No.: US 2011/0100978 A1
(43) Pub. Date: May 5, 2011

(54) APPARATUS FOR SHAPING MELTS COMPRISING INORGANIC OXIDES OR MINERALS WITH AN IMPROVED HEATING DEVICE

(75) Inventor: Michael Oechsle, Salach (DE)

(73) Assignee: UMICORE AG & CO. KG, HANAU-WOLFGANG (DE)

(21) Appl. No.: 12/809,488

(22) PCT Filed: Dec. 12, 2008
(86) PCT No.: PCT/EP08/67198

§ 371 Date: Jan. 21, 2011

Related U.S. Application Data
(60) Provisional application No. 61/060,692, filed on Jun. 11, 2008.

(30) Foreign Application Priority Data
Dec. 19, 2007 (DE) 10 2007 061 695.5

(51) Int. Cl. H05B 3/02

(52) U.S. Cl. 219/438

(57) ABSTRACT

Fibers, pipes, rods, strips or profiles made of high-melting inorganic oxides or minerals are used in great quantities, for example for reinforcing plastics, ceramics and metals. In order to produce said products, use is made of apparatuses comprising a melt container with an individual orifice, or orifice plate with a multiplicity of orifices, arranged in the base of the melt container. The melt in the melt container has to be kept at as homogeneous as possible an operating temperature above the individual orifice or orifice plate. For this purpose, the melt container is usually heated by a direct through flow of current. This results in high radiation losses to the surroundings and to a correspondingly high need for electric energy. It is proposed, for the heating of the melt, to arrange one or more pipes in the melt container, the pipes having at least one connection to the outside through the container casing, and electric heating elements being inserted into the pipes. This type of heating results in a homogeneous temperature distribution of the melt above the individual orifice or the orifice plate and permits an energy saving of more than 50%.

The invention relates to an apparatus for shaping melts comprising inorganic oxides or minerals, in particular for producing glass fibers and basalt fibers. The apparatus contains a melt container with a container casing and an individual orifice or orifice plate arranged in the base of the melt container.

Fibers, tubes, rods, strips or profiles made of high-melting inorganic oxides or minerals are produced in large amounts. Fibers from said materials are used, for example for reinforcing plastics, ceramics and metals.

An early apparatus for the production of glass threads is shown in the patent publication GB 361,220. The cylindrical heating chamber is made from refractory material, such as burnt fireclay or heat resisting metal alloy, and along one side is provided with one or more spinning nozzles through which the glass can be withdrawn from the chamber. Within the heating chamber is arranged a plurality of heating elements parallel to the cylinder axis. Each consists of a tube manufactured from porcelain or heat resisting metal alloys having arranged on their inner surface an electrical resistance. This apparatus, due to the preferred use of burnt fireclay and porcelain, cannot cope with today's quality requirements and the required diversity of raw materials for the fibers. In case the apparatus is manufactured from refractory metal alloys the heating current will flow through the whole apparatus because heating element, resistance and heating chamber form an integral unit.

The today's apparatuses for manufacturing glass fibers or mineral fibers predominantly consist of alloys of the platinum group metals and are heated by direct current flowing through the casing of the apparatus. Such apparatuses contain a melt container with an individual orifice or orifice plate arranged in the base of the melt container. The melt container may be a tub, a trough, a cone, a cylinder or the like. The melt in the melt container has to have as homogeneous as possible a temperature distribution above the individual orifice or orifice plate so that fibers, without disturbances of the drawing process, can be drawn from all of the shaping orifices having the same fiber cross section. An orifice plate can be equipped with several hundred individual orifices for shaping fibers. Apparatuses with an orifice plate are shown in laid-open specifications DE 196 38 056 A1, US 2003/0145631 A1 and US 2003/09041627 A1; an apparatus with an individual orifice is described in DE 101 08 831 C1.

The inorganic oxides or minerals are melted in a furnace using known methods and are introduced into the apparatus. In the case of remelt processes, the apparatus is connected directly to the furnace; in direct-melt processes, the apparatus is fixedly connected to a distributor channel. Metals, in particular platinum and platinum alloys, are usually used as the materials for the apparatus and for the orifice plate and orifices. Because of the high thermal conductivity of the metals, the apparatus is insulated against heat loss in order to ensure a constant viscosity of the melt and as homogeneous as possible a temperature distribution above the individual orifice or orifice plate. By contrast, the individual orifice or the orifice plate in the base of the melt container cannot be thermally insulated, and therefore transfer of heat convection and radiation of heat to the colder surroundings occur. The heat loss is usually compensated for by a higher operating temperature of the melt and by direct electric heating of the metallic apparatus and thus results in a high energy consumption. As a consequence of the heat loss to the surroundings, there is a temperature gradient and, associated therewith, a viscosity gradient in the melt.

It is the object of the present invention to specify an apparatus for shaping melts comprising inorganic oxides or minerals, the apparatus having a more homogeneous temperature distribution in the melt and a significantly reduced energy consumption than conventional apparatuses of this type.

This object is achieved by means of an apparatus (1) for shaping melts comprising inorganic oxides or minerals, the apparatus containing a melt container (2) with a container casing (3, 4) and an orifice plate (7) with a plurality of orifices (8), or an individual orifice, arranged in the base (6) of the melt container. In the apparatus, one or more pipes (9) are located in the melt container. The pipes having at least one connection/opening to the outside through the container casing, and wherein electric heating elements (10) are inserted into the pipes. The melt container (2), the individual orifice or orifice plate (7) and the tubes (9) are manufactured from platinum, palladium or alloys thereof with one or more metals selected from rhodium, iridium and gold.

The heating elements or heating cartridges may be commercially available heating elements which can be obtained e.g. from the company Kanthal for working temperatures up to 1850° C. It is essential for the invention that the heating elements are electrically isolated from the tubes in which they are inserted. Contrary to GB 361,220 the apparatus according to the invention is not heated by direct current flowing through the casing of the melt container.

According to the invention, the temperature of the melt is kept at an operating temperature with the aid of the heating elements inserted into the pipes. The heat source for heating the melt is therefore placed directly into the melt. The heat is delivered to the melt by thermal conduction and radiation of heat. As a result, in comparison to the direct heating of the metallic apparatus, the heat losses of the heating system to the surroundings are reduced by more than 50%. Bus bars are also no longer required for introducing the current into the metallic apparatus, and therefore precious metal can be saved. In addition, the apparatus according to the invention makes it possible for the temperature of the melt to be easily adjusted.

The apparatus is suitable both for an orifice plate with several hundred orifices and also for individual orifices. In the first case, the melt container has a rectangular base surface and is delimited by four side walls. In this case, it is advantageous if the pipes together with the heating elements are guided between two opposite container walls and a plurality of such pipes are arranged parallel to one another. Such an apparatus is suitable for the mass manufacturing of technical fibers from glass or minerals. If, by contrast, container glass and high-grade technical glass are to be formed, then it is expedient to use an apparatus with just a few orifices or just one individual orifice. The melt container is then in the form of a pot, cone or cylinder. In this case, the pipe for heating the melt can be designed as a closed circular pipe. The heating pipe is therefore matched to the internal geometry of the melt container. A supply pipe leads from the outside through the casing of the melt container and is connected to the circular pipe. The heating element is inserted into the circular pipe via the supply pipe and is supplied with electric energy.

The container casing of the apparatus, the individual orifice or the orifice plate and the pipes are manufactured from platinum, palladium or alloys of said platinum metals with one or more of the metals rhodium, iridium and gold. In order to satisfy more high temperature strength requirements, the platinum or the platinum alloy can be stabilized by oxidic material finely distributed in the metal. Zirconium oxide and yttrium oxide are particularly suitable for stabilization purposes. The heating pipes are welded to the container casing so as to provide a seal against the melt escaping.

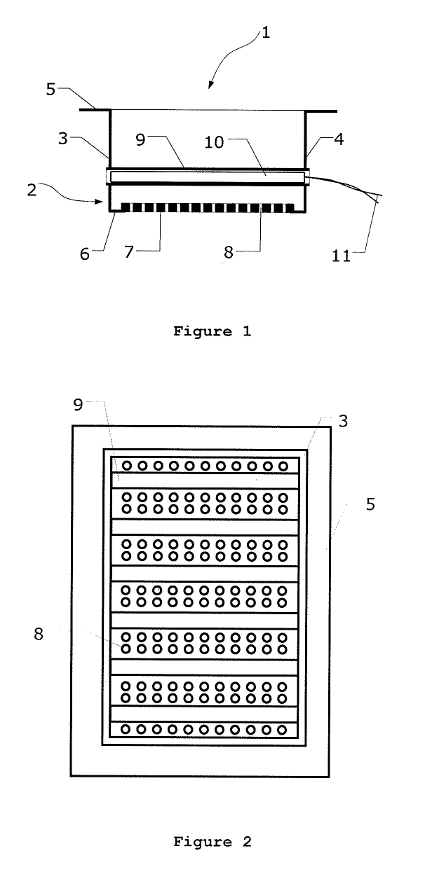

The invention is explained in more detail with reference to an exemplary embodiment and FIGS. 1 to 6, in which:

FIG. 1 shows a cross section through an apparatus according to the invention with an orifice plate and several hundred orifices

FIG. 2 shows a view from above of the apparatus from FIG. 1

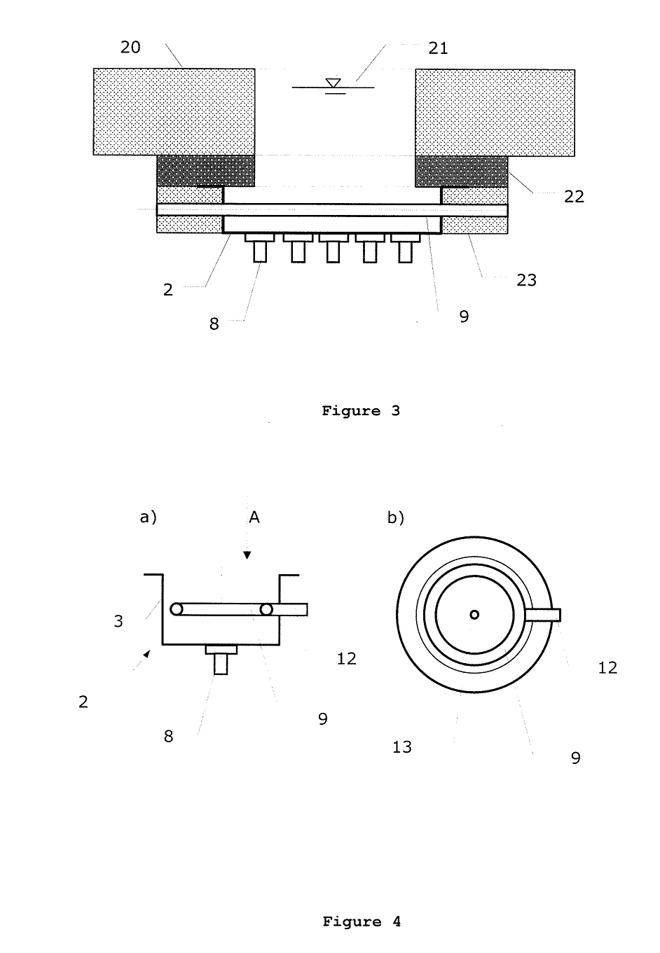

FIG. 3 shows an apparatus as in FIG. 1 with a ceramic bushing block to the forehearth channel and ceramic insulating compound

FIG. 4 shows an apparatus with an individual orifice

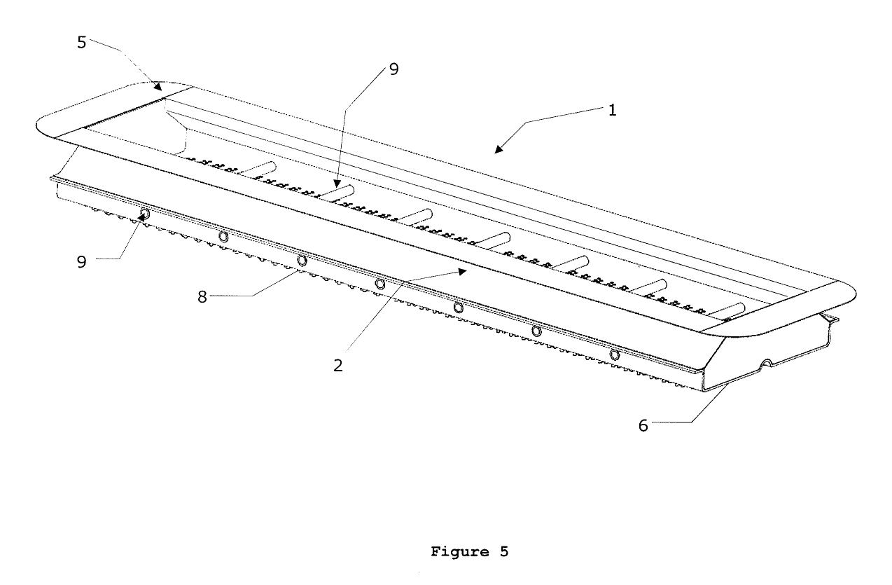

FIG. 5 shows a perspective view of an apparatus with an orifice plate and several hundred orifices without a covering sieve

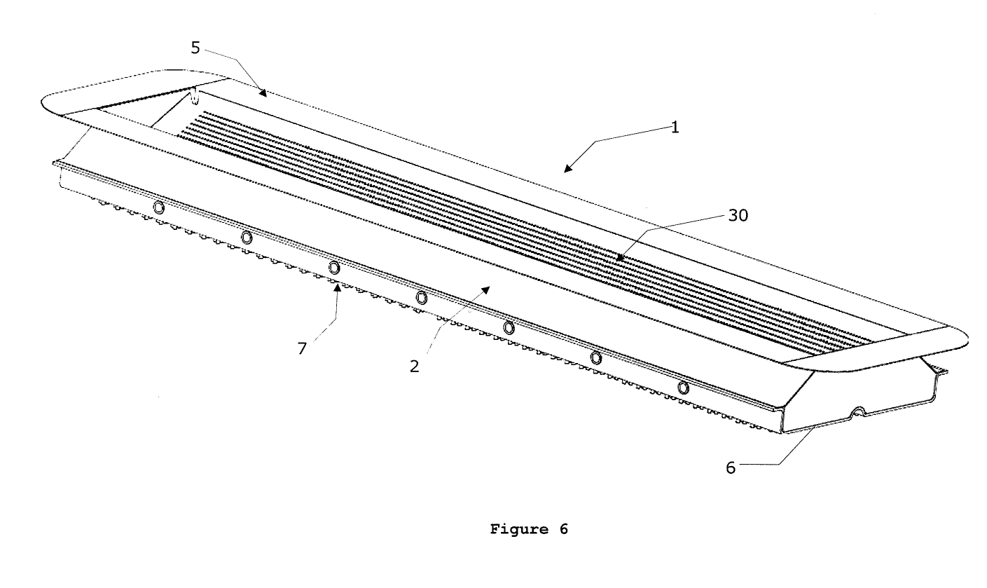

FIG. 6 shows a perspective view of the apparatus from FIG. 5 with a covering sieve.

FIG. 1 shows a cross section through a particular embodiment of the apparatus (1) according to the invention. The apparatus comprises the melt container (2) with a container casing (3, 4) and a circumferential flange (5) which encircles it on the upper side and is intended for fixing the melt container to a forehearth channel. An orifice plate (7) with the orifice openings (8) is embedded in the base (6) of the melt container. The orifice openings may be simple through boreholes or deep-drawn orifices or else separately manufactured orifices. During operation, the entire interior of the melt container is filled with the melt. Above the orifice plate, in this embodiment of the apparatus, through pipes (9) are arranged between two opposite sections of the container casing (3, 4) and are guided through the container casing. Said pipes are preferably provided with a round cross section, but may also have any other expedient cross-sectional shape. Electric heating cartridges (10) with the connecting wires (11) guided outward are inserted in said pipes. To maintain the operating temperature of the melt, the heating cartridges are supplied with electric current. FIG. 2 shows a view from above of the apparatus from FIG. 1. The same reference numbers denote the same elements as in FIG. 1.

FIG. 3 shows an apparatus, the melt container (2) of which is integrally cast in a ceramic insulating compound (23) for the purpose of heat insulation. The forehearth channel (20) is arranged directly above the apparatus. The longitudinal extent of the forehearth channel shown in FIG. 3 is perpendicular to the plane of the drawing. A further ceramic brick or bushing block (22) serves as the adapter block and for heat insulation. The forehearth channel (20) is filled to the level (21) with a melt. The melt passes from a furnace via the forehearth channel directly into the apparatus. The melt container (2) is completely filled with the melt. As in FIG. 1, the apparatus is equipped with through pipes (9). The through pipes are guided through bores in the ceramic embedding compound (23).

FIGS. 1 to 3 show embodiments of the apparatus with a multiplicity of orifices (8). By contrast, FIG. 4 shows an apparatus with just one individual orifice (8) for shaping container glass and high-grade technical glass. FIG. 4a) shows a cross section through the apparatus while FIG. 4b) shows a view of the apparatus in the direction of the arrow A. For heating purposes, the melt container (2) contains a pipe (9) which is bent and joined together to form a circular ring. The circular pipe is connected to a feed pipe (12) which is guided through the container casing (3) and is welded thereto and permits a heating element to be inserted into the heating pipe (9). Reference number (13) denotes the orifice bore which is visible from above.

FIG. 5 shows an apparatus according to FIG. 1 in a perspective view. The arrangement of the through pipes (9) can be seen clearly. FIG. 6 shows the same illustration as in FIG. 5, but with a sieve covering (30) over the through pipes. The sieve among other things has the task of collecting undissolved particles occasionally contained in the melt and of thereby preventing the orifices from becoming clogged.

### Example

The temperature distribution within the apparatus according to FIG. 1 and the temperature profile under the orifice plate for conventional direct heating and for the heating according to the invention by means of the heating cartridges inserted into the through pipes have been determined with the aid of simulation calculations. The calculations were based on an apparatus having the following dimensions: length=510 mm; width=160 mm; height=50 mm; sheet-metal thickness=1.5 mm. It was assumed that the apparatus was equipped with 2400 orifices having a clear diameter of 2 mm. Such an apparatus is capable of spinning 1500 kg of glass per day to form glass fibers with a diameter of 13 μm. The calculations were made using the known thermal properties of platinum, glass and ceramic. The table below lists the material data used:

TABLE
Material data used for the simulation
calculations

| | Ceramic | Platinum | Glass |
|---|---|---|---|
| Density g/cm³ | 1.4 | 21.45 | 2.63 |
| Thermal | 3 | 71.6 | 0.8 |
| conductivity | | | |
| W/mK | | | |
| Heat | 800 | 130 | 800 |
| capacity | | | |
| J/kg K | | | |
| Emissivity | 0.42-0.26 | 0.036-0.192 | 0.95-0.85 |
| | (499-826° C.) | (RT-1.226° C.) | (260-540° C.) |

RT = room temperature

The simulation calculations supplied the following result:

During conventional, direct heating of the apparatus, a heating power of 21 kW is required in order to keep the melt at an operating temperature of 1125° C. A large part of the thermal energy introduced into the orifice plate by the resistance heating is radiated directly downward. If, by contrast, the same heating power is introduced directly into the glass melt via the through pipes, then the temperature of the melt increases just above the orifice plate to more than 1400° C. During conventional heating, the melt within the melt container already has a sharp temperature drop from the upper edge to the orifice plate. In the case of the heating according to the invention, this temperature gradient is virtually nonexistent. Furthermore, during conventional direct heating of the metal apparatus, a lateral temperature gradient with a temperature drop from the outside to the center is obtained. In the case of heating according to the invention, this temperature gradient is virtually nonexistent too.

With the same input of energy as in conventional heating, the heating according to the invention therefore results in more uniform heating of the melt. Heat is now transferred directly from the heating source through the pipes to the melt and finally to the melt container with the orifice plate. The heat is therefore not radiated directly to the surroundings. However, because of the smaller heat losses during heating according to the invention, the melt heats up much too severely, and therefore the amount of heat supplied has to be reduced. Only with a reduction of the heating power to 3.9 kW were approximately identical temperature conditions as during conventional heating at 21 kW obtained. The heating according to the invention therefore permits the input of energy in order to maintain the operating temperature of the melt to be reduced to approximately one fifth.

Of course, the indirect heating according to the invention of the apparatus can be used not only in the case of apparatuses having a multiplicity of orifices, but can advantageously also be used in the case of individual orifices.

The apparatus is preferably used for producing fibers, tubes, rods, strips or profiles made of high-melting inorganic oxides or minerals.

1. An apparatus for shaping melts comprising inorganic oxides or minerals, the apparatus containing a melt container with a container casing and an individual orifice, or orifice plate with a plurality of orifices, arranged in the base of the melt container, wherein one or more pipes are located in the melt container, the pipes having at least one connection to the outside through the container casing, and wherein electric heating elements are inserted into the pipes and the melt container, the individual orifice or orifice plate and said one or more pipes are manufactured from platinum, palladium or alloys thereof with one or more metals selected from rhodium, iridium and gold.

2. The apparatus as claimed in claim 1, wherein the pipes together with the heating elements are arranged between two opposite sections of the container casing and are guided through the container casing.

3. The apparatus as claimed in claim 2, wherein the precious metal or the precious metal alloy is stabilized by oxidic material finely distributed in the metal.

4. The apparatus as claimed in claim 1, wherein 1 to 25 orifices per square centimeter are embedded in the orifice plate.

5. The apparatus as claimed in claim 1, wherein only one individual orifice is present in the base of the apparatus.

6. The use of the apparatus as claimed in claim 1 for producing fibers, pipes, rods, strips or profiles made of high-melting inorganic oxides or minerals.

7. A method of shaping melts comprising inorganic oxides or minerals, comprising:
providing a melt of inorganic oxides or minerals within a melt container, with the melt container having a container casing with one or more orifices;
heating the melt while in the melt container with one or more heating elements positioned within one or more pipes located in the melt container and electrically isolated from said melt container;
outputting the melt heated by the one or more heating elements thought the one or more orifices; and
wherein the melt is placed in contact with surfaces of said apparatus that are manufactured from platinum, palladium or alloys thereof with one or more metals selected from rhodium, iridium and gold.

8. The method of claim 7 wherein heating the melt includes heating to a temperature of more than 1400° C.

9. The method of claim 8 wherein the melt is placed in contact with the one or more pipes.

10. The method of claim 7 wherein outputting the melt includes passing melt through a plurality of orifices in an orifice plate.

11. The method of claim 10 wherein heating the melt includes heating up a plurality of the one or more pipes, each with an electrically isolated heater element received therein, and which pipes are spaced apart along the orifice plate.

12. The method of claim 7 wherein heating the melt includes contacting the melt with an annular shaped pipe having an electrically isolated heater element and with one orifice positioned below and in a central region of a cavity defined by the annular shaped pipe.

13. The method of claim 7 wherein providing the melt includes placing melt up to a fill line positioned above the melt container by way of supplying melt to a reception region of a support structure which is supporting the melt container.

14. The method of 13 wherein the support structure includes apertures for receiving the one or more pipes.

15. A method of assembly an apparatus for shaping melts of inorganic oxides or minerals comprising;
providing a support structure; and
securing a melt container to the support structure with the melt container having a container casing with one or more orifices for melt dispensing,
providing one or more pipes so as to extend within the melt container;
positioning one or more heater elements within said one or more pipes such that they are electrically isolated from the pipes and the melt container, and
wherein surfaces of the melt container, one or more orifices, and one or more pipes that are positioned for contact with the melt are manufactured from platinum, palladium or alloys thereof with one or more metals selected from rhodium, iridium and gold.

16. The method of claim 15 further comprising inserting one or more of the pipes within an aperture formed in the support structure.

17. The method of claim 16 further comprising integrally casting the melt container in a ceramic insulating compound and wherein the one or more pipes are arranged as to extend through bores formed in the ceramic insulating compound.

18. The method of claim 15 wherein there is provided an annular shaped pipe which defines an interior cavity having a central axis aligned with one of said one or more orifices and a heating element is received within the annular shaped pipe.

19. The method of claim 15 wherein securing the melt container includes securing a melt container that has a plurality of orifices in an orifice plate at the base of the melt container.

20. The method of claim 19 wherein positioning one or more heater elements includes positioning heater elements within a plurality of pipes spaced apart along and above the orifice plate with groups of orifices spaced to sides of said plurality of pipes.
